(19) United States
(12) Patent Application Publication
(10) Pub. No.: US 2010/0241999 A1
(43) Pub. Date: Sep. 23, 2010

(54) Canvas Manipulation Using 3D Spatial Gestures

(75) Inventors: V. Kevin Russ, Bellevue, WA (US); John A. Snavely, Seattle, WA (US); Edwin R. Burtner, Everett, WA (US); Ian M. Sands, Seattle, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/407,128

(22) Filed: Mar. 19, 2009

(51) Int. Cl. G06F 3/033

(52) U.S. Cl. 715/863; 715/848

(57) ABSTRACT

User interface manipulation using three-dimensional (3D) spatial gestures may be provided. A two-dimensional (2D) user interface (UI) representation may be displayed. A first gesture may be performed, and, in response to the first gesture's detection, the 2D UI representation may be converted into a 3D UI representation. A second gesture may then be performed, and, in response to the second gesture's detection, the 3D UI representation may be manipulated. Finally, a third gesture may be performed, and, in response to the third gesture's detection, the 3D UI representation may be converted back into the 2D UI representation.

### RELATED APPLICATIONS

Related U.S. application No. ______, entitled “Tear-Drop Object Indication” (14917.1222US01), related U.S. application No. ______, entitled “Dual Module Portable Device” (14917.1224US01), and U.S. application No. ______, entitled “Projected Way-Finding” (14917.1223US01), filed on even date herewith, assigned to the assignee of the present application, are hereby incorporated by reference.

### BACKGROUND

In some situations, a user may desire to simultaneously display multiple documents or multiple programs running on a computing device. However, the user's display device may not have a sufficiently large screen or a sufficient resolution to effectively provide the desired display. Thus, the conventional strategy to overcome this deficiency is to couple multiple display devices to one computing device and configure each display device to represent a respective user interface portion. This often problematic because the conventional strategy requires additional space, time, and resources to purchase, install, configure, and operate the multiple display devices. Furthermore, the conventional strategy results in a fragmented user interface with dead space in between the display devices.

### SUMMARY

This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

Canvas manipulation using three-dimensional (3D) spatial gestures may be provided. A two-dimensional (2D) user interface (UI) representation may be displayed. A first gesture may be performed, and, in response to the first gesture's detection, the 2D UI representation may be converted into a 3D UI representation. A second gesture may then be performed, and, in response to the second gesture's detection, the 3D UI representation may be manipulated. Finally, a third gesture may be performed, and, in response to the third gesture's detection, the 3D UI representation may be converted back into the 2D UI representation.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a diagram of an operating environment;

FIG. 2 is a flow chart of a method for providing canvas manipulation using 3D spatial gestures; and

FIG. 3 is a block diagram of a system including a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

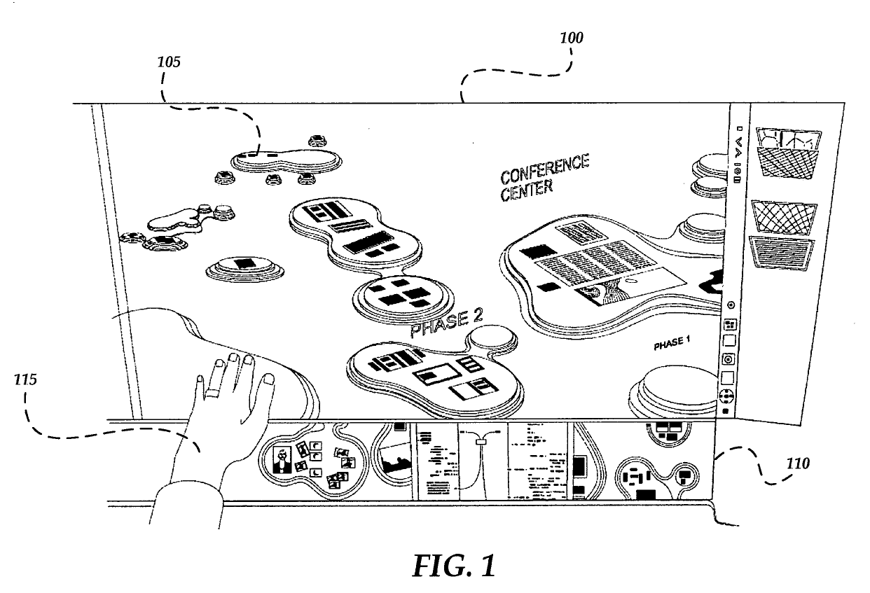

FIG. 1 is diagram of an operating environment. As shown in FIG. 1, by performing gestures in proximity to a display device 100, a user may control which user interface portions 105 are visible on the display device. In this way, a user interface having displayable components extending beyond a displayable portion of display device 100 may expose different user interface components for display upon gesture detection. The gestures may be performed, for example, by the user's hand 115 and detected by a detection device (not shown) in proximity to display device 100. Specific gestures may indicate specific manipulations to the user interface. For instance, initially, a 2D user interface representation may be displayed at display device 100. Upon detecting a first user gesture directed towards display device 100, the 2D user interface representation may be converted into a 3D user interface representation. Similarly, upon detecting a second user gesture directed away from display device 100, the 3D user interface representation may be restored back into the 2D user interface representation, as described in more detail below.

Embodiments of the invention may allow the user to manipulate the 3D user interface representation. For example, while the 3D user interface representation is being displayed, the user may perform hand gestures indicating user interface rotation, propagation, or any other user interface manipulations. In this way, the user's gestures may be correlated with respective manipulations in the 3D user interface. For instance, the user may have his hand 115 initially positioned perpendicularly (or approximately perpendicular) to the display device with, for example, his fingers pointing towards display device 100. From the perpendicular position, by way of example, the user may angle their hand 115 towards the right to indicate a desired user interface rotation towards the right. Accordingly, the user may angle their hand 115 in any direction to indicate a desired user interface rotation in the corresponding angled direction.

Similarly, the user may perform gestures to zoom into or out of the 3D representation of the user interface. In this way, combining the angled and zooming hand gestures, the user may simulate ‘propagation’ through the user interface as though their hand gestures were controlling the roll, pitch, and yaw of the simulated propagation. This may be done, for example, by moving the user's hand 115 towards display device 100 to indicate a zoom, or propagation, into the user interface, and by moving the user's hand 115 away from display device 100 to indicate a zoom, or prorogation, out of the user interface. In addition, the user may perform gestures with both of their hands in unison. For example, the user's left hand may indicate a rate of user interface manipulation, while the user's right hand may indicate a type of user interface manipulation.

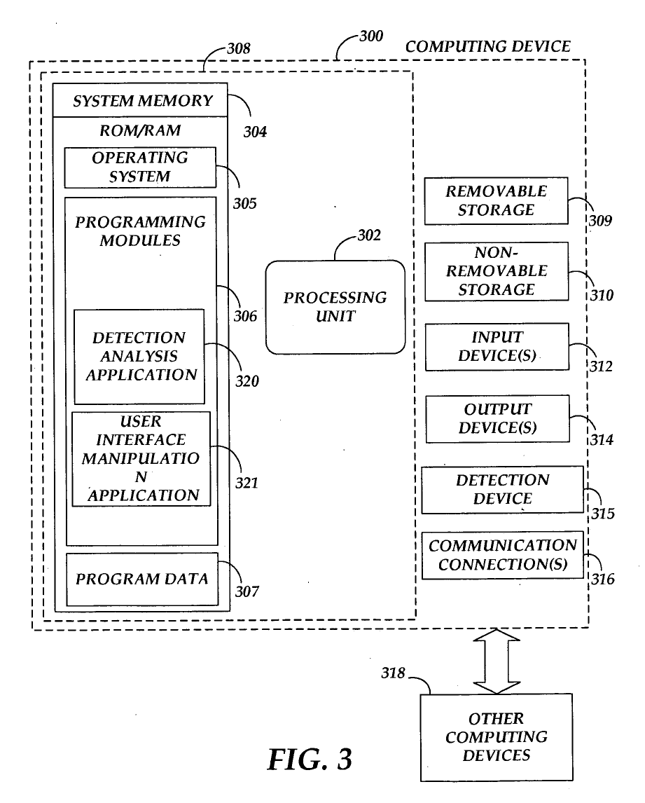

Moreover, embodiments of the invention may use a gesture detection device, for example, a detection device 315 as described in more detail below with respect to FIG. 3. For example, upon detection of a user gesture by the detection device, the detection device may signal a computing device (e.g. a computing device 300 as described in more detail below with respect to FIG. 3) coupled to display device 100 of the detected gesture. Consistent with embodiments of the invention, the detection device may detect the user gesture and access a memory storage coupled to the detection device to in order to determine a specific signal associated with the gesture. The determined signal may then be relayed to the computing device where a corresponding instruction may be executed. In various other embodiments of the invention, the detection device may signal, for example, detection information associated with the gesture and the computing device may subsequently determine an action associated with the detected information. The gesture detection device may comprise at least one detection component positioned at various points in an operating environment consistent with embodiments of the invention. The detection component may utilize sound waves or electromagnetic waves to detect user gestures. For example, a web cam coupled with image analysis software may be used to detect the user's gestures. Moreover, acceleration and deceleration of the user gestures may be detected and relayed to the computing device to provide user interface manipulation at a corresponding acceleration and deceleration rate.

In addition, embodiments of the invention may provide a system for manipulating a user interface using spatial gestures. For example, display device 100 may display a user interface as either a 3D representation or a 2D representation. The user interface may comprise displayed user interface portions 105 and hidden user interface portions 110 (shown in FIG. 1 for illustrative purposes). With the user's hand 115, the user may perform gestures to manipulate the user interface in order to display hidden user interface portions 110. The displayed user interface portions 105 may be represented as 3D objects or as 2D objects occupying a portion or an entirety of display device 100. Such 2D or 3D representation of the displayed user interface portions 105 may be manipulated based on hand gestures performed by the user's hand 115, as described in greater detail below. With these hand gestures, the user may navigate to any portion of the user interface, hidden or displayed, and zoom in on a particular user interface portion. Once the user has navigated to the particular user interface portion, the user may then perform hand gestures in order to expand the representation of the particular user interface portion to the entirety of display device 100, in either a 2D or 3D representation.

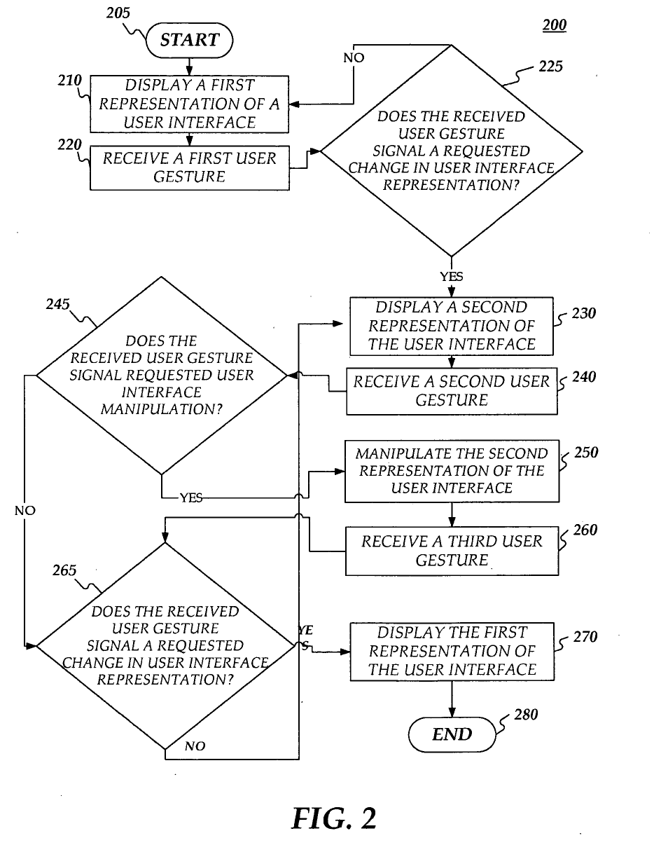

FIG. 2 is a flow chart setting forth the general stages involved in a method 200 consistent with embodiments of the invention for providing user interface manipulation using 3D spatial gestures. Method 200 may be implemented using computing device 300 as described in more detail below with respect to FIG. 3. Ways to implement the stages of method 200 will be described in greater detail below.

Method 200 may begin at starting block 205 and proceed to stage 210 where computing device 300 may display a first user interface representation. For example, display device 100 coupled to computing device 300 may present the user interface in a 2D representation. This 2D representation may comprise displayable elements that may not be displayed at the display device. For instance, the display device may not have a sufficient resolution or a larger enough screen to display the entirety of the user interface. Consequently, the display device may only display a first user interface portion.

From stage 210, where computing device 300 displays the first user interface representation, method 200 may advance to stage 220 where computing device 300 may receive a first user gesture detection. For example, a detection device, as detailed above, may detect a first hand gesture by a user of computing device 300. The first hand gesture may indicate that the user would like to change a representation of the user interface from the first representation to a second representation. With the second user interface representation, the user may view additional user interface portions not displayable by the first user interface representation, as described in greater detail below.

Once computing device 300 receives the first user gesture detection in stage 220, method 200 may continue to decision block 225 where computing device 300 may determine if the received first gesture corresponds to a requested change in user interface representation. For example, in order to indicate a request to change the user interface representation from the first representation to the second representation, the user may perform a first hand gesture. The first hand gesture may comprise a motion of the user's hand from an initial position with the palm approximately parallel the display device and the fingers pointing upward, to a subsequent position with the palm approximately perpendicular to the display device and the fingers pointing towards the display device. In other embodiments of the invention, the first hand gesture may comprise a displacement of the user's hand towards the display device.

If computing device 300 determines that the received first gesture does not correspond to a requested change in user interface, method 200 may proceed to stage 210 where computing device 300 may continue to display the first representation of the user interface. Otherwise, after computing device 300 determines that the received first gesture corresponds to the requested change in the user interface, method 200 may continue to stage 230 where computing device 300 may display a second user interface representation. For example, the second user interface representation may be a 3D user interface representation. In this way, the second user interface representation may represent the first user interface portion, displayed initially in the first user interface representation, in a 3D perspective. This second, 3D representation may also display user interface portions that were not displayable in the first representation. For instance, the first, 2D user interface representation may be converted into the second, 3D user interface representation, exposing previously hidden user interface portions. This conversion may be portrayed at the display device by having the 2D user interface representation pivot, along a horizontal axis of the 2D representation, into the display device, thereby shifting the perspective of the upper portion of the 2D representation towards a ‘horizon’ of the 3D representation. Consequently, user interface portions that were previously out of view in the first representation may now be viewed in the second representation.

While computing device 300 displays the second representation of the user interface in stage 230, method 200 may proceed to stage 240 where computing device 300 may receive a second user gesture detection. For example, by performing hand gestures associated with user interface manipulation, the user may navigate through the second user interface representation by rotating the user interface, zooming into or out of the user interface, or otherwise manipulating the second user interface representation. In this way, the user may expose undisplayed user interface portions in either the first representation or initial second representation.

Once computing device 300 receives the second user gesture detection in stage 240, method 200 may continue to decision block 245 where computing device 300 may determine if the received second user gesture corresponds to a requested user interface manipulation. For example, in order to indicate a request to change the user interface representation from the first representation to the second representation, the user may perform a second hand gesture. The second hand gesture may comprise a motion of the user's hand from an initial position with the user's palm approximately perpendicular to the display device and the fingers pointing towards the display device, to a subsequent angle at the user's wrist in an upward, downward, or side to side motion. In this way, the corresponding angle of the user's hand may correspond to a direction of user interface rotation. In various embodiments of the invention, the second hand gesture may comprise a displacement of the user's hand toward or away from the display device, resulting in a respective zoom in or zoom out of the user interface.

If computing device 300 determines that the received second user gesture does not correspond to a requested user interface manipulation, method 200 may proceed to decision block 265 where computing device 300 may determine if the received second gesture corresponds to a requested change in user interface representation. Otherwise, after computing device 300 determines that the received second gestures corresponds to the requested user interface manipulation, method 200 may continue to stage 250 where computing device 300 may manipulate the second representation of the user interface. For example, if the user has angled their hand to the right, the second user interface representation may be rotated towards the right about a vertical axis. Similarly, if the user has angled their hand upward, the second user interface representation may be rotated upwards about a horizontal axis. In this way, the user may expose user interface portions not previously displayed. Moreover, the user may use both hands to manipulate the user interface. For example, the user's right hand gestures may control a direction of propagation through the 3D user interface representation, while the user's left hand may control a rate of propagation through the user interface. With these user interface manipulations, the user may navigate to previously undisplayable user interface portions.

Once computing device 300 manipulates the second user interface representation in accordance with the second received user gesture in stage 250, method 200 may proceed to stage 260 where computing device 300 may receive a third user gesture. For example, the user may have navigated to a desired user interface portion and may like to see the desired user interface portion in the initial, first user interface representation. Accordingly, the user may perform a third gesture to indicate a request to display the desired user interface portion in the first representation.

Upon receipt of the third gesture by computing device 300, method 200 then proceeds to decision block 265 where computing device 300 may determine if the received third gesture corresponds to a requested change in user interface representation. For example, in order to indicate a request to change the user interface representation from the second representation to the first representation, the user may perform a third hand gesture. The third hand gesture may comprise a motion of the user's hand from an initial position with the palm approximately perpendicular to the display device and the fingers pointing towards the display device, to a subsequent position with the palm approximately parallel with the display device and the fingers pointing upwards. In other embodiments of the invention, the third hand gesture may comprise a displacement of the user's hand away from the display device.

If computing device 300 determines that the received first third gesture does not correspond to a requested change in user interface, method 200 may proceed to stage 230 where computing device 300 may continue to display the second representation of the user interface. Otherwise, after computing device 300 determines that the received third gesture corresponds to the requested change in the user interface, method 200 may continue to stage 270 where computing device 300 may display the first user interface representation. For example, the first user interface representation may now include the desired user interface portion the user has navigated to. In this way, where the display device may have initially displayed the first user interface portion in stage 210 of method 200, the display device may now display a second user interface portion corresponding to the user's interface navigation. After computing device 300 has restored the first representation of the user interface, method 200 may either to end at stage 280, or return to stage 220 where method 200 may be repeated.

Embodiments consistent with the invention may comprise a system for displaying information based on gesture detection. The system may comprise a memory storage and a processing unit coupled to the memory storage. The processing unit may be operative to display a first, 2D user interface representation. While displaying the 2D user interface representation, the processing unit may be further operative to receive user gesture detection, and, in response to the detection, display a 3D user interface representation.

Other embodiments consistent with the invention may comprise a system for providing multi-dimensional user interface navigation based on gesture detection. The system may comprise a memory storage and a processing unit coupled to the memory storage. The processing unit may be operative to display a first, 2D user interface representation. While displaying the 2D user interface representation, the processing unit may be further operative to receive a first user gesture detection, and, in response to the detection, display a 3D user interface representation. Furthermore, the processing unit may receive a second user gesture detection, and, in response to the detection, manipulate the 3D user interface representation.

Various additional embodiments consistent with the invention may comprise a system for providing displaying information based on gesture detection. The system may comprise a display device operative to display a 2D representation of a user interface and a 3D representation of the user interface; a gesture detection device operative to detect hand gestures and send signals corresponding to the detected hand gestures; a memory storage for storing a plurality of instructions associated with the detected hand gestures; and a processing unit coupled to the display device, the gesture detection device, and the memory storage. The processing unit may be operative to cause a display of a first user interface representation or a second user interface representation; receive signals indicative of a detected hand gesture; determine instructions associated with detected hand gestures; and cause a display of the user interface in accordance with the determined instructions.

FIG. 3 is a block diagram of a system including computing device 300. Consistent with an embodiment of the invention, the aforementioned memory storage and processing unit may be implemented in a computing device, such as computing device 300 of FIG. 3. Any suitable combination of hardware, software, or firmware may be used to implement the memory storage and processing unit. For example, the memory storage and processing unit may be implemented with computing device 300 or any of other computing devices 318, in combination with computing device 300. The aforementioned system, device, and processors are examples and other systems, devices, and processors may comprise the aforementioned memory storage and processing unit, consistent with embodiments of the invention. Furthermore, computing device 300 may comprise an operating environment for system 100 as described above. System 100 may operate in other environments and is not limited to computing device 300.

With reference to FIG. 3, a system consistent with an embodiment of the invention may include a computing device, such as computing device 300. In a basic configuration, computing device 300 may include at least one processing unit 302 and a system memory 304. Depending on the configuration and type of computing device, system memory 304 may comprise, but is not limited to, volatile (e.g. random access memory (RAM)), non-volatile (e.g. read-only memory (ROM)), flash memory, or any combination. System memory 304 may include operating system 305, one or more programming modules 306, and may include a program data 307 for storing various instructions associated with detected gestures. Operating system 305, for example, may be suitable for controlling computing device 300's operation. In one embodiment, programming modules 306 may include a detection analysis application 320, as well as user interface manipulation application 321 that may be operatively associated with detection analysis application 320. Furthermore, embodiments of the invention may be practiced in conjunction with a graphics library, other operating systems, or any other application program and is not limited to any particular application or system. This basic configuration is illustrated in FIG. 3 by those components within a dashed line 308.

Computing device 300 may have additional features or functionality. For example, computing device 300 may also include additional data storage devices (removable and/or non-removable) such as, for example, magnetic disks, optical disks, or tape. Such additional storage is illustrated in FIG. 3 by a removable storage 309 and a non-removable storage 310. Computer storage media may include volatile and nonvolatile, removable and non-removable media implemented in any method or technology for storage of information, such as computer readable instructions, data structures, program modules, or other data. System memory 304, removable storage 309, and non-removable storage 310 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 300. Any such computer storage media may be part of device 300. Computing device 300 may also have input device(s) 312 such as a keyboard, a mouse, a pen, a sound input device, a touch input device, etc. Output device(s) 314 such as a display, speakers, a printer, etc. may also be included. Furthermore, computing device 300 may comprise detection device 315 that may be in direct or indirect communication with detection analysis application 320 and user interface manipulation application 321. Detection device 315 may comprise, for example, multiple acoustic or electromagnetic detection components, positioned at various areas of the operating environment. Display device 100 may comprise one of output device(s) 314. The aforementioned devices are examples and others may be used.

Computing device 300 may also contain a communication connection 316 that may allow device 300 to communicate with other computing devices 318, such as over a network in a distributed computing environment, for example, an intranet or the Internet. Communication connection 316 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 304, including operating system 305. While executing on processing unit 302, programming modules 306, such as detection analysis application 320 and user interface manipulation application 321, may perform processes including, for example, one or more of method 200's stages as described above. The aforementioned process is an example, and processing unit 302 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A computer-readable medium that stores a set of instructions which when executed perform a method for displaying information based on gesture detection, the method comprising:
displaying a first representation of a user interface at a display device, the first representation of the user interface being a two-dimensional (2D) representation of the user interface;
detecting a first user gesture; and
displaying, in response to detecting the first user gesture at the display device, a second representation of the user interface, the second representation of the user interface being a three-dimensional (3D) representation of the user interface.

2. The computer-readable medium of claim 1, wherein detecting the first user gesture comprises:
detecting an object positioned approximately parallel with a screen of the display device, and
detecting a change in the object's position to an approximately perpendicular position to the screen of the display device.

3. The computer-readable medium of claim 2, further comprising:
detecting a second user gesture while displaying the second representation of the user interface, wherein detecting the second gesture comprises:
detecting the object positioned approximately perpendicular to the screen of the display device, and
detecting the object subsequently positioned approximately parallel with the screen of the display device; and
displaying, in response to detecting the second user gesture, the first representation of the user interface.

4. The computer-readable medium of claim 1, wherein displaying the first representation of the user interface comprises displaying a first portion of the user interface in the first representation of the user interface, and wherein displaying, in response to detecting the first user gesture, the second representation of the user interface comprises displaying a second portion of the user interface in the second representation of the user interface.

5. The computer-readable medium of claim 4, wherein displaying the second portion of the user interface in the second representation of the user interface comprises displaying at least a segment of the first portion of the user interface in the second representation of the user interface.

6. The computer-readable medium of claim 5, further comprising:
detecting a second user gesture while displaying the second representation of the user interface, wherein detecting the second gesture comprises:
detecting an object positioned approximately perpendicular to a screen of the display device, and
detecting the object subsequently angled from its approximate perpendicular position; and
displaying, in response to detecting the second user gesture, a third portion of the user interface in the second representation of the user interface.

7. The computer-readable medium of claim 6, wherein displaying, in response to detecting the second user gesture, the third portion of the user interface in the second representation of the user interface comprises displaying at least one of the following:
at least a segment of the second portion of the user interface in the second representation of the user interface, and
at least a segment of the first portion of the user interface in the second representation of the user interface.

8. The computer-readable medium of claim 7, further comprising:
detecting a third user gesture while displaying the second representation of the user interface; and
displaying, in response to detecting the third user gesture, at least one of the following:
at least a segment of the first portion of the user interface in the first representation of the user interface,
at least a segment of the second portion of the user interface in the first representation of the user interface, and
at least a segment of the third portion of the user interface in the first representation of the user interface.

9. The computer-readable medium of claim 8, wherein detecting the third user gesture while displaying the second representation of the user interface comprises:
detecting the object positioned approximately perpendicular to the screen of the display device, and
detecting the object subsequently positioned approximately parallel with the screen of the display device.

10. A method for multi-dimensional user interface navigation based on gesture detection, the method comprising:
displaying a two-dimensional (2D) representation of a user interface at a display device;
detecting a first user gesture;
displaying, in response to detecting the first user gesture, a three-dimensional (3D) representation of the user interface at the display device;
detecting a second user gesture while displaying the 3D representation of the user interface; and
manipulating, in response to detecting the second user gesture, the 3D representation of the user interface.

11. The method of claim 10, wherein displaying, in response to detecting the first user gesture, the 3D representation of the user interface comprises converting the 2D representation of the user interface into the 3D representation of the user interface by pivoting the 2D representation of the user interface about a first pivot point parallel to a horizontal axis of the 2D representation of the user interface.

12. The method of claim 10, wherein displaying the 3D representation of the user interface comprises exposing portions of the user interface not displayed in the 2D representation of the user interface.

13. The method of claim 10, wherein detecting the first user gesture comprises:
detecting an object at an initial proximity to the display device, and
detecting the object at a subsequent proximity to the display device, the subsequent proximity to the display device being in closer proximity to the display device than the initial proximity to the display device.

14. The method of claim 10, wherein detecting the second user gesture while displaying the 3D representation of the user interface comprises:
detecting a first object at an initial angle, and
detecting the first object at a subsequent angle.

15. The method of claim 14, wherein manipulating, in response to detecting the second user gesture, the 3D representation of the user interface comprises manipulating the 3D representation of the user interface by one of the following:
rotating the 3D representation of the user interface around any axis of the 3D representation of the user interface,
propagating through the 3D representation of the user interface,
zooming into the 3D representation of the user interface, and
zooming out of the 3D representation of the user interface.

16. The method of claim 15, further comprising:
detecting a third user gesture while manipulating the 3D representation of the user interface, wherein detecting the third user gesture while displaying the 3D representation of the user interface comprises:
detecting a second object at an initial angle, and
detecting the second object at a subsequent angle; and
adjusting, in response to detecting the third user gesture, a rate of user interface manipulation.

17. The method of claim 10, further comprising:
detecting a third user gesture while displaying the 3D representation of the user interface, wherein detecting the third user gesture comprises:
detecting an object at an initial proximity to the display device, and
detecting the object at a subsequent proximity to the display device, wherein the initial proximity to the display device is in closer proximity to the display device than the subsequent proximity to the display device; and
displaying, in response to detecting the third user gesture, at least a segment of the manipulated 3D representation of the user interface in the 2D representation of the user interface.

18. A system for displaying information based on gesture detection, the system comprising:
a display device operative to display a two-dimensional (2D) representation of a user interface and a three-dimensional (3D) representation of the user interface;
a gesture detection device operative to detect hand gestures and send signals corresponding to the detected hand gestures;
a memory storage for storing a plurality of instructions associated with the detected hand gestures; and
a processing unit coupled to the display device, the gesture detection device, and the memory storage, wherein the processing unit is operative to:
cause a display of a first portion of the user interface in the 2D representation of the user interface;
receive a first signal indicative of a first detected hand gesture from the gesture detection device,
determine a first set of instructions associated with the first detected hand gesture from the plurality of instructions in the memory storage, wherein the first set of instructions provides instructions to cause a display of a second portion of the user interface in the 3D representation of the user interface,
cause a display of the user interface in accordance with the determined first set of instructions,
receive a second signal indicative of a second detected hand gesture from the gesture detection device,
determine a second set of instructions associated with the second detected hand gesture from the plurality of instructions in the memory storage, wherein the second set of instructions provides instructions to manipulate the 3D representation of the user interface,
manipulate the 3D representation of the user interface in accordance with the determined second set of instructions,
receive a third signal indicative of a third detected hand gesture from the gesture detection device,
determine a third set of instructions associated with the third detected gesture from the plurality of instructions in the memory storage, wherein the third set of instructions provides instructions to cause a display of a viewable portion of the manipulated 3D representation of the user interface when displayed in the 2D representation of the user interface, and
cause a display of the viewable portion of the manipulated 3D representation of the user interface in the 2D representation of the user interface.

19. The system of claim 18, wherein the second set of instructions comprises at least one of the following instructions to:
rotate the 3D representation of the user interface,
zoom into the 3D representation of the user interface,
zoom out of the 3D representation,
pivot the 3D representation of the user interface about an X-axis of the 3D representation of the user interface,
pivot the 3D representation of the user interface about a Y-axis the 3D representation of the user interface, and
pivot the 3D representation of the user interface about a Z-axis the 3D representation of the user interface.

20. The system of claim 18, wherein the 2D representation of the user interface comprises at least a segment of the viewable portion of the manipulated 3D representation of the user interface.
